(19) United States
(12) Patent Application Publication
(10) Pub. No.: US 2008/0212767 A1
(43) Pub. Date: Sep. 4, 2008

(54) METHOD OF ROUTING PROSPECTIVE OR CURRENT CUSTOMER INFORMATION REQUESTS TO FIND THE BEST CURRENTLY AVAILABLE STAFF MEMBER

(76) Inventor: Joseph A. Charlson, Pittsburgh, PA (US)

Correspondence Address: ECKERT SEAMANS CHERIN & MELLOTT, 600 GRANT STREET, 44TH FLOOR, PITTSBURGH, PA, 15219, US

(21) Appl. No.: 12/015,095

(22) Filed: Jan. 16, 2008

Related U.S. Application Data
(60) Provisional application No. 60/885,066, filed on Jan. 16, 2007.

(51) Int. Cl. H04M 3/00

(52) U.S. Cl. 379/265.09

(57) ABSTRACT

A method of routing customer inquires for an organization using an inbound or outbound caller or online echatter, typically in a call center, including steps of engaging in a communication with a customer wherein the customer provides an information inquiry, determining a number of staff members of the organization that are appropriate for responding to the inquiry, sending a first electronic message from the call center to each of the number of staff members for determining whether the staff member is immediately available for responding to the inquiry, receiving a second electronic message from one or more responding staff members indicating that the associated staff member is immediately available for responding to the inquiry (a positive behavioral response), selecting the best qualified staff member of those available, and facilitating direct communication between the selected staff member and the prospective customer.

### CROSS-REFERENCE TO RELATED APPLICATIONS

This application claims the benefit of U.S. Provisional Application No. 60/885,066, entitled “Customer Routing of Customer Information Requests,” which was filed on Jan. 16, 2007, the disclosure of which is incorporated herein by reference.

### FIELD OF THE INVENTION

The present invention relates to call centers, and in particular to a method of improving the routing of customer inquiries that are processed through a customer call center (which may be a traditional telephone call center, a chat center as described herein, or some combination thereof) to other staff members that can more fully respond to the customer inquiry. The call center may be a collection of geographically collocated agents or a collection of geographically dispersed agents (“virtual” non-collocated individuals) performing the same customer engagement function, e.g. fielding in-bound calls, making out-bound calls, or engaging in customer-initiated or agent-initiated web chat, text messaging, or instant messaging, or some combination thereof.

### BACKGROUND OF THE INVENTION

As is well known in the art, a call center is a functional area within an organization or an outsourced, third party facility whose purpose is to answer inbound or place outbound telephone calls for a wide range of purposes, including, but not limited to, sales and marketing and customer assistance and support. In addition, a call center may also function as an online “chat center” for providing similar functionality wherein, instead of communicating by traditional telephone, individuals, such as current or prospective customers, are able to communicate with a call center staff member in real time over the Internet using a properly equipped PC or a similar device such as a PDA and tools such as an instant messaging application (for a “text chat”) or voice over IP (VOIP) technology (for a “voice chat”). A particular call center may also employ both methodologies just described in order to serve current or prospective customers with varying communication preferences (some may prefer a traditional phone call while others may prefer to “chat” online).

For example, a business or some other organization may employ a call center (internally and/or through an outsourced third party facility) to receive telephone calls from current customers or interested prospective customers and to attempt to route/transfer those calls to the appropriate sales force personnel within the business. Many businesses employ what is known as a distributed sales force wherein each of a number of different portions/divisions and/or locations of the business has its own sales office (and therefore its own team of team of sales professionals). Thus, when a call center is employed in such a situation, each call that is fielded by the call center will need to be transferred to the appropriate sales office associated with the particular portion/division and/or location that is the subject of the call. In current call centers, when the call center receives such calls, they try to transfer the call to the appropriate sales office (at the appropriate portion/division and/or location) through the existing telephone system. In particular, the call center staff member handling the call places a telephone call to the appropriate sales office seeking to find a member of that sales office that is immediately available to field the inquiry from the current or prospective customer. In addition, the search for a member of the sales office may be a focused search which actually searches for a sales person that is best suited to handle the inquiry as determined by certain distribution logic. For example, the focused search may be based on criteria such as (i) each sales person's immediate availability; (ii) each sales person's area of specialization (as compared to the interest of the customer); (iii) each sales person's skill level; and/or (iv) each sales person's utilization, inquiry load versus their personal target for a given time period.

A significant problem being experienced by organizations that employ call centers as described above is that often times the call center personnel cannot locate a member of the appropriate sales force fast enough in order to immediately transfer the call. Typically, the call center staff member will place a call to the distributed sales force to attempt to transfer the customer call and allows that call to ring for a certain period of time, and if nobody responds within a reasonable time period (e.g., 30 to 60 seconds), the attempt to transfer the call is abandoned. The phone system utilized by the distributed sales force may have a routing queue which progressively bounces from line to line after a set number of rings. Still, in such a case, if nobody responds within a reasonable time period, the attempt to transfer the call will be abandoned by the call center staff member. As a result, the success rate of transferring inbound calls received at a call center directly and immediately to an appropriate member of the distributed sales force is often rather low (sometimes as low as 40% or less). As will be appreciated, since it is the prospective customer that has initiated the contact in these cases, it is particularly desirable to make the connection to an appropriate member of the distributed sales force immediately so as not to miss the opportunity to have direct contact with a prospective customer that is both interested and ready and willing at that time to engage in a conversation. As will be appreciated, a similar problem exists with call centers that provide online chat capability since, based on the content of the chat, the call center staff member will typically try to immediately facilitate a telephone phone conversation between the prospective customer and a member of the sales force. The same challenge exists when a call center initiates the contact through outbound calls to prospective or current customers to qualify their interest in speaking with a sales person and then the call center employee attempts to locate the best available sales person in a distributed office. Thus, there is room for improvement in the area of routing requests that are processed through a call center.

### SUMMARY OF THE INVENTION

In one embodiment, a method of routing customer inquires for an organization using a call center is provided. The method includes steps of engaging in a communication with a customer (current or prospective) from the call center wherein the customer provides an information inquiry, determining at the call center a number of staff members of the organization that are appropriate for responding to the information inquiry, and sending a first electronic message from the call center to each of the number of staff members for determining whether the staff member is immediately available for responding to the information inquiry. The method further includes receiving at the call center a second electronic message from one or more of the number of staff members, each electronic message indicating that the associated staff member is immediately available for responding to the information inquiry, selecting at the call center one of the so responding staff members, and facilitating a direct communication, preferably a direct telephone call (although it may be a direct electronic communication such as a real time chat) between the selected staff member and the customer.

In one particular embodiment, the engaging step comprises engaging in an inquiry telephone call with a customer (current or prospective) from the call center, which may be initiated by the customer (in the case of an incoming call center), or, alternatively a staff member of the call center (in the case of an outgoing call center). In this embodiment, the facilitating step preferably includes transferring the inquiry telephone call from the call center to the selected staff member.

Alternatively, the engaging step may include engaging an online chat (e.g., a text chat or a voice chat) with a customer (current or prospective) from the call center. In this embodiment, the facilitating step may comprise initiating from the call center a three-way telephone call that includes a staff member of the call center, the selected staff member, and the customer and thereafter having the staff member of the call center exit the three-way telephone call, or instructing the selected staff member to place a direct telephone call to the customer, or instructing the customer to place a direct telephone call to the selected staff member, or the call center staff member can facilitate the connection via a direct electronic initiation of the 2-way call between the customer and the selected sales person (similar to “click-to-call” type technology).

The organization may have a distributed sales force having a plurality of distributed sales locations. In such a case, the step of determining at the call center a number of staff members of the organization that are appropriate for responding to the information inquiry comprises selecting one of the distributed sales locations, wherein the number of staff members of the organization to which the first electronic messages are sent are each associated with the selected distributed sales location.

The particular staff member that is chosen may be selected in a number of different ways. For example, the first staff member to respond may be selected. Alternatively, of the available responders, the particular staff member may be chosen based on skill level, expertise, and/or performance in closing sales. Other predetermined selection logic is also possible to apply to the group of available responders.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a schematic diagram of a system for routing customer inquiries according to one particular embodiment of the present invention;

FIG. 2 is a flowchart illustrating a method of routing customer inquiries using the system shown in FIG. 1 according to one particular embodiment of the present invention;

FIG. 3 is a schematic diagram of a system for routing customer inquiries according to another particular embodiment of the present invention; and

FIG. 4 is a flowchart illustrating a method of routing customer inquiries using the system shown in FIG. 3 according to another particular embodiment of the present invention.

### DESCRIPTION OF THE PREFERRED EMBODIMENTS

As employed herein, the statement that two or more parts or components are “coupled” together shall mean that the parts are joined or operate together either directly or through one or more intermediate parts or components.

As employed herein, the term “number” shall mean one or an integer greater than one (i.e., a plurality).

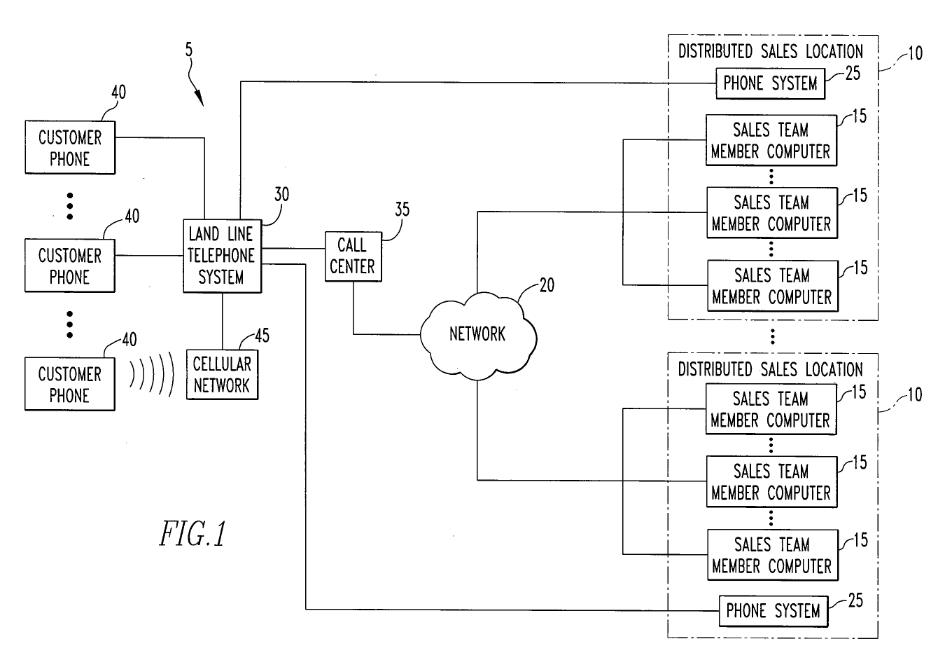

FIG. 1 is a schematic diagram of a system 5 for routing customer inquiries according to one particular embodiment of the present invention. The system 5 shown in FIG. 1 is employed by a business (or other organization) having a distributed sales force. It should be understood, however, that this is meant to be exemplary and not limiting, and that the present invention may be used by organization that do not have a distributed sales force.

As seen in FIG. 1, the system 5 includes a number of distributed sales locations 10, each of which has its own team or force of sales professionals. In addition, a plurality of sales team member computers 15 are located at each distributed sales location 10 for use by the sales team of the distributed sales location 10. Each sales team member computer 15 is operatively coupled to a network 20, which may be one or more wired and/or wireless communications networks alone or in various combinations, and may include, without limitation the Internet. Furthermore, each distributed sales location 10 includes a phone system 25 for use by the sales team members in communicating with customers (current or prospective) as described in detail elsewhere herein. As will be appreciated, the phone system 25 at each distributed sales location 10 will preferably include a phone for use by each sales team member. In the embodiment shown in FIG. 1, each phone system 25 is operatively coupled to the land line telephone system 30.

The system 5 further includes a call center 35 as generally described elsewhere herein. The call center 35 may be operated internally by the business which is employing the system 5, may be operated by a third party in an outsourcing arrangement with the business employing the system 5, or some combination thereof. As shown in FIG. 1, the call center 35 is operatively coupled to the network 20. In particular, the call center 35 includes a computer for use by each member of the call center staff that is equipped with one or more messaging applications, such as an instant messaging application and/or an e-mail application, to enable each call center staff member to transmit electronic messages to and receive electronic messages from each sales team member computer 15 through the network 20 (as will be appreciated, each sales team member computer 15 is similarly equipped with such applications). Furthermore, the call center 35 includes a phone system having a plurality of phones for use by the members of the call center staff to communicate by telephone with customers as described herein. In particular, the system 5 contemplates a number of customer phones 40 which are used by and under the control of customers who are interested in communicating with the business which employs the system 5. The customer phones 40 may be land line phones which are operatively coupled to the landline telephone system 30 to enable the customer to communicate with the call center staff members, or, alternatively, one or more of the customer phones 40 may be a cellular phone that employs a cellular network 45 in communication with the land line telephone system 30 to enable such customers to communicate with the call center staff members.

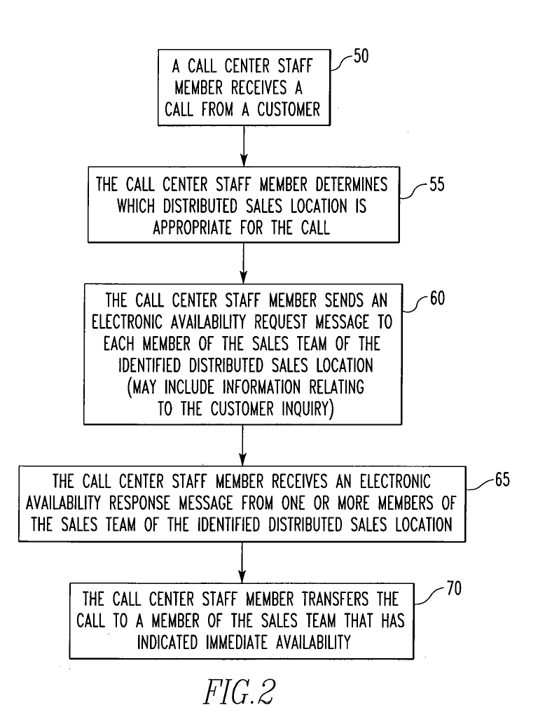

FIG. 2 is a flowchart illustrating a method of routing customer inquiries using the system 5 shown in FIG. 1 according to one particular embodiment of the present invention. As demonstrated herein, the method shown in FIG. 2 will result in a much greater likelihood that a customer that places a call from a customer phone 40 to a call center staff member at the call center 35 will be successfully and immediately transferred from the call center 35 to a member of the sales team of the appropriate distributed sales location 10.

The method begins at step 50, wherein a call center staff member working at the call center 35 receives a call from a customer using that customer's customer phone 40 (as described elsewhere herein, in an alternative embodiment, the contact with a customer may also be made by initiating an outbound call). Next, at step 55, the call center staff member determines, based upon information provided by the customer, which distributed sales location 10 is appropriate for the call. For example, the customer may indicate to the call center staff member that he or she is interested in a particular product or service of or a particular physical location of the business employing the system 5, and based on that information, the call center staff member will determine which distributed sales location 10 is appropriate. Then, at step 60, the call center staff member will generate and send an electronic availability request message to each member of the sales team of the identified distributed sales location 10. Specifically, an electronic message, such as an instant message or an e-mail, is generated by the call center staff member using his or her computer and is transmitted through the network 20 to each sales team member computer 15 at the appropriate distributed sales location 10. In the preferred embodiment, the electronic message is sent in a targeted manner to the sales team member computer 15 of the sales team members that meet certain specified criteria (e.g. dedicated to the specific customer segment, above average performance, capacity utilization, etc.). Typically, the electronic availability request message will indicate that the call center 35 has received an inquiry from a customer who wishes to speak with a member of the sales team of the identified distributed sales location 10. Other information relating to the nature of the inquiry, such as the specific product and/or service that is interested, specific concerns, customer database ID number, etc, may optionally be included in the electronic availability request message. In addition, the electronic availability request message will request a response from each member (preferably targeted member) of the sales team of the identified distributed sales location 10 that is currently immediately available to handle the customer inquiry.

Upon receiving the electronic availability request message, a number of the members of the sales team of the identified distributed sales location 10 will respond appropriately with an affirmative behavioral response that they are in fact available to handle the call. Specifically, in step 65, the call center staff member that sent the electronic availability request message in step 60 will receive, at his or her computer, an electronic availability response message from one or more of the sales team members (preferably targeted members) of the identified distributed sales location 10. Each of the electronic availability response messages will indicate that the member of the sales team is in fact currently immediately available to handle the customer inquiry. Each electronic availability response message is preferably transmitted from the respective sales team member computer 15 to the call center 35 through the network 20 using the same type of message that was used to transmit the electronic availability request messages, e.g., an instant message or an e-mail message. Then, at step 70, the call center staff member transfers the customer's call through the landline telephone system 30 and the phone system 25 to one of the sales team members that has indicated immediate availability. The particular member of the sales team to which the call is transferred may be selected in a number of different ways. For example, the call center staff member may choose to transfer the call to the first member of the sales team to respond to the electronic availability request message. Alternatively, calls may be transferred to particular responding members of the sales team based upon certain predetermined logic. For example, the call center staff member may be instructed to transfer the call to a particular one of the responding members of the sales team that responds within a certain window (e.g., a 30 second window). The particular responding member to which the call is transferred may, for example, be a member that has certain expertise in a particular area (e.g., certain expertise relating to a particular product and/or service) or certain skills. Alternatively, a greater number of calls may be preferentially transferred to particular responding members of the sales team who are better performers in terms of closing sales. In other words, the call center staff member may be instructed to transfer the call based upon a priority determined by the closing performance of the members of the sales team.

The method shown in FIG. 2 applies to situation where the call center 35 in FIG. 1 is operating as an inbound call center, meaning that the calls are initiated by the customers to the call center staff members. The call center 35 may, however, also be operated as an outbound call center wherein call center staff members call customers on their customer phones 40. For example, this may be done in response to a prior information request received from a customer, such as by returning a postcard or the like indicating an interest to the business implementing the system 5. In such a situation, an alternative to the method shown in FIG. 2 may be implemented in order to improve the routing of customer inquires. In particular, step 50 shown in FIG. 2 can be replaced by a step wherein a call center staff member calls a customer on that customer's customer phone 40 in order to initiate the contact with the customer. Thereafter, the remainder of the method steps shown in FIG. 2 would be performed in order to connect the customer immediately to an appropriate member of the sales team of the appropriate distributed sales location 10.

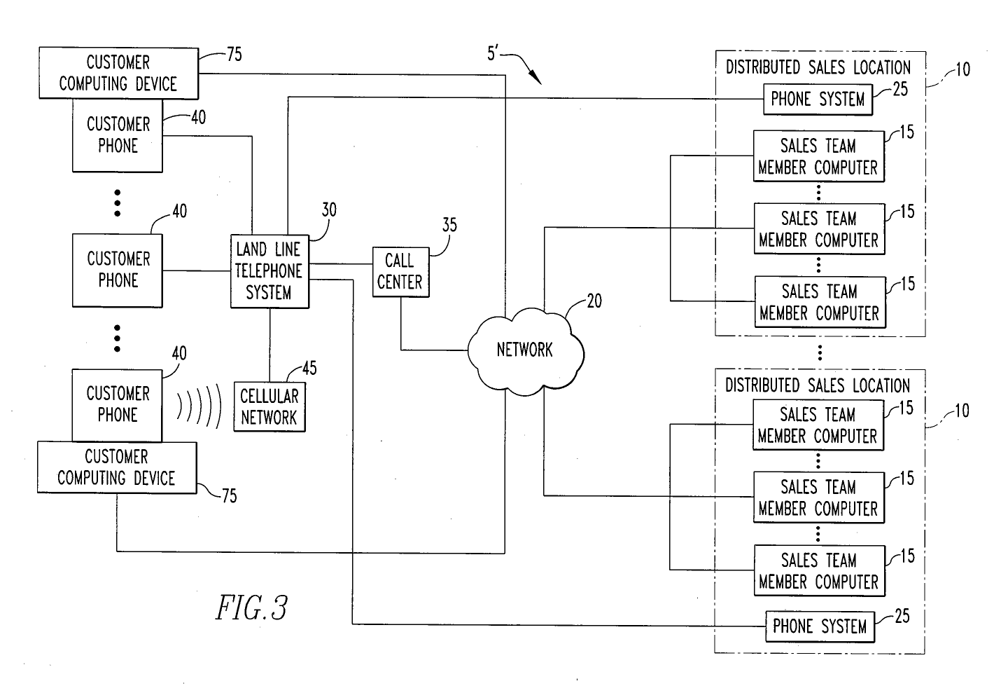

FIG. 3 is schematic diagram of a system 5′ for routing customer inquiries according to an alternative embodiment of the invention. In the system 5′, the call center 35 is implemented to function as an online “chat center” as described elsewhere herein. This functionality may be the only type of call center functionality provided by the call center 35, or may be in addition to the more traditional telephone call call center functionality described in connection with FIG. 1. Thus, as shown in FIG. 3, a number of the customers will, in addition to having a customer phone 40, also have a customer computing device 75, such as a PC or other suitable device like a PDA or Smartphone. Each customer computing device 75 is operatively coupled to the network 20, either in a wired fashion, a wireless fashion, or some combination thereof, so that the customer is able to engage in an online chat (a “text chat” or a “voice chat”) as described elsewhere herein with a call center staff member through a computer provided at the call center 35.

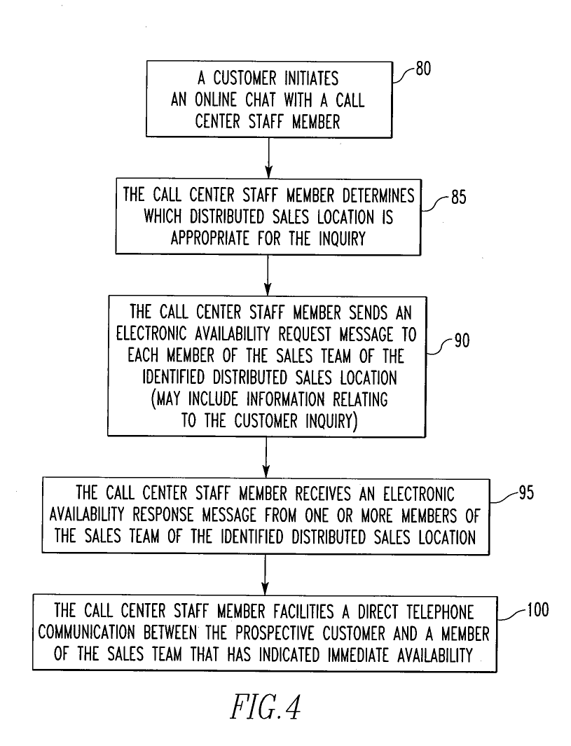

FIG. 4 is a flowchart illustrating a method of routing inquiries using the system 5′ shown in FIG. 3 according to one particular embodiment. The method begins at step 80, wherein a customer initiates an online chat with a call center staff member using that customer's customer computing device 75. Next, at step 85, the call center staff member determines, based upon information provided by the customer during the chat session, which distributed sales location 10 is appropriate for handling the inquiry. Then, at step 90, the call center staff member will generate and send an electronic availability request message to each member of the sales team of the identified distributed sales location 10 as described in greater detail elsewhere herein. In step 95, the call center staff member that sent the electronic availability request message in step 80 will receive, at his or her computer, an electronic availability response message from one or more members of the sales team of the identified distributed sales location 10. As described elsewhere herein, each of the electronic availability response messages will indicate that the member of the sales team is in fact currently immediately available to handle the customer inquiry. Next, at step 100, the call center staff member facilitates a direct telephone communication between the customer and a selected member (i.e., selected as described elsewhere herein) of the sales team of the identified sales location 10 that has indicated immediate availability. This may be done in a number of ways. For example, the call center staff member may facilitate this telephone communication by first initiating a three-way telephone call by calling the selected member of the sales team through the phone system 25 at the identified distributed sales location 10 and then calling the customer through the landline telephone system 30 (and if appropriate the cellular network 45) to make the initial introduction between the customer and the selected member of the sales team. Thereafter, the call center staff member can exit the three-way call, thereby completing the establishment of the call between the customer and the identified member of the sales team. Preferably, the call center staff member first privately speaks with the identified member of the sales team before bringing the customer into the three-way telephone call. Alternatively, the call center staff member can instruct the selected member of the sales team to initiate a call directly to the customer on the customer's customer phone 40. The call center staff member preferably does this by sending an electronic message to the selected member of the sales team through the network 20. As a further alternative, the call center staff member can instruct the customer to directly call the selected member of the sales team immediately. As will be appreciated, the phone number of the member of the sales team can be provided to the customer in the current ongoing chat session. As a further alternative, the call center staff member can facilitate the connection via a direct electronic initiation of the 2-way call between the customer and the selected sales person (similar to the “click-to-call” type technology). In this embodiment, the call center staff member can electronically provide the detailed text chat record to the selected member of the sales team to better prepare the sales team member to respond to the customer's concerns and needs.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method of routing customer inquires for an organization using a call center, comprising:
engaging in a communication with a customer from said call center wherein said customer provides an information inquiry;
determining at said call center a number of staff members of said organization that are appropriate for responding to said information inquiry;
sending a first electronic message from said call center to each of said number of staff members for determining whether the staff member is immediately available for responding to said information inquiry;
receiving at said call center a second electronic message from one or more of said number of staff members, said one or more of said number of staff members being responding staff members, each said electronic message indicating that the associated responding staff member is immediately available for responding to said information inquiry;
selecting at said call center one of said responding staff members;
facilitating a direct communication between the selected one of said responding staff members and said customer.

2. The method according to claim 1, wherein said facilitating comprises facilitating a direct telephone call between the selected one of said responding staff members and said customer.

3. The method according to claim 2, wherein said engaging comprises engaging in an inquiry telephone call with a customer from said call center.

4. The method according to claim 3, wherein said inquiry telephone call is initiated by the customer.

5. The method according to claim 3, wherein said inquiry telephone call is initiated by said call center.

6. The method according to claim 3, wherein said facilitating a direct telephone call between the selected one of said responding staff members and said customer comprises transferring said inquiry telephone call from said call center to the selected one of said responding staff members.

7. The method according to claim 1, wherein said engaging comprises engaging in an online chat with said customer from said call center.

8. The method according to claim 7, wherein said online chat is an online text chat.

9. The method according to claim 7, wherein said online chat is an online voice chat.

10. The method according to claim 2, wherein said engaging comprises engaging in an online chat with a customer from said call center.

11. The method according to claim 10, wherein said facilitating a direct telephone call between the selected one of said responding staff members and said customer comprises initiating from said call center a three-way telephone call that includes a staff member of said call center, the selected one of said responding staff members, and said customer and thereafter having said staff member of said call center exit the three-way telephone call.

12. The method according to claim 11, wherein said staff member of said call center first privately speaks with said selected one of said responding staff members before bringing said customer into said three-way telephone call.

13. The method according to claim 10, wherein said facilitating a direct telephone call between the selected one of said responding staff members and said customer comprises instructing the selected one of said responding staff members to place a direct telephone call to said customer.

14. The method according to claim 10, wherein said facilitating a direct telephone call between the selected one of said responding staff members and said customer comprises instructing said customer to place a direct telephone call to the selected one of said responding staff members.

15. The method according to claim 10, wherein said facilitating a direct telephone call between the selected one of said responding staff members and said customer comprises a direct electronic initiation of a two-way telephone call between the customer and the selected one of said responding staff members by said call center.

16. The method according to claim 2, wherein said organization has a distributed sales force having a plurality of distributed sales locations, wherein said determining at said call center a number of staff members of said organization that are appropriate for responding to said information inquiry comprises selecting one of said distributed sales locations, said responding staff members being associated with the selected one of said distributed sales locations.

17. The method according to claim 2, wherein said selecting at said call center one of said responding staff members comprises selecting the one of said responding staff members associated with the one of the second electronic messages that is first received at said call center.

18. The method according to claim 2, wherein said selecting at said call center one of said responding staff members comprises selecting the one of said responding staff members based on a respective area or areas of expertise of each of said responding staff members.

19. The method according to claim 2, wherein said selecting at said call center one of said responding staff members comprises selecting the one of said responding staff members based on a respective sales closing performance of each of said responding staff members.

20. The method according to claim 2, wherein said selecting at said call center one of said responding staff members comprises selecting the one of said responding staff members based on a respective skill level of each of said responding staff members.

21. The method according to claim 2, wherein the selected one of said responding staff members is the one of the responding staff members determined to be best qualified to handle the information inquiry based on certain predetermined selection logic.

22. The method according to claim 21, wherein following said selecting said facilitating a direct telephone call between the selected one of said responding staff members and said customer is performed automatically and immediately.

23. The method according to claim 1, wherein said facilitating comprises facilitating a direct electronic communication between the selected one of said responding staff members and said customer.

24. The method according to claim 1, wherein said call center is a collocated call center having geographically collocated staff members.

25. The method according to claim 1, wherein said call center is a non-collocated call center having geographically dispersed staff members.

26. The method according to claim 1, wherein said call center is hybrid of a collocated call center having certain geographically collocated staff members and a non-collocated call center having geographically dispersed staff members.

27. A method of responding to customer inquires relating to an organization using a call center, comprising:
in response to said call center (i) engaging in a communication with a customer wherein said customer provides an information inquiry and (ii) determining a number of staff members of said organization that are appropriate for responding to said information inquiry, receiving a plurality of first electronic messages from said call center, each of said first electronic messages being sent to a respective one of said number of staff members for determining whether the staff member is immediately available for responding to said information inquiry;
sending to said call center a second electronic message from one or more of said number of staff members, said one or more of said number of staff members being responding staff members, each said electronic message indicating that the associated responding staff member is immediately available for responding to said information inquiry; and
participating in a direct communication between one of said responding staff members that is selected by said call center and said customer.

28. The method according to claim 27, wherein said direct communication comprises a direct telephone call.

29. The method according to claim 28, wherein said communication with a customer comprises an inquiry telephone call between the prospective customer and said call center.

30. The method according to claim 29, wherein said inquiry telephone call is initiated by the customer.

31. The method according to claim 29, wherein said inquiry telephone call is initiated by said call center.

32. The method according to claim 29, wherein said direct telephone call results from said inquiry telephone call being transferred from said call center to the selected one of said responding staff members.

33. The method according to claim 27, wherein said direct communication comprises an online chat.

34. The method according to claim 33, wherein said online chat is an online text chat.

35. The method according to claim 33, wherein said online chat is an online voice chat.

36. The method according to claim 28, wherein said engaging comprises engaging in an online chat with said customer from said call center.

37. The method according to claim 36, wherein said direct telephone call between the selected one of said responding staff members and said customer results from a three-way telephone call initiated from said call center that includes a staff member of said call center, the selected one of said responding staff members, and said customer wherein after initiation said staff member of said call center exits the three-way telephone call.

38. The method according to claim 37, wherein selected one of said responding staff members first privately speaks with said staff member of said call center before said customer is brought into said three-way telephone call.

39. The method according to claim 36, wherein said direct telephone call between the selected one of said responding staff members and said customer results from the selected one of said responding staff members placing a direct telephone call to said customer in response to instructions received from said call center.

40. The method according to claim 36, wherein said direct telephone call between the selected one of said responding staff members and said customer results from said selected one of said responding staff members receiving a direct telephone call from said customer in response to instructions received from said call center.

41. The method according to claim 36, wherein said direct telephone call between the selected one of said responding staff members and said customer results from a two-way telephone call being directly electronically initiated between the customer and the selected one of said responding staff members by said call center.

42. The method according to claim 28, wherein said organization has a distributed sales force having a plurality of distributed sales locations, and wherein said responding staff members are associated with one of said distributed sales locations selected by said call center.

43. The method according to claim 28, wherein said one of said responding staff members that is selected is the one of said responding staff members associated with the one of the second electronic messages that is first received at said call center.

44. The method according to claim 28, wherein said one of said responding staff members is selected based on a respective area or areas of expertise of each of said responding staff members.

45. The method according to claim 28, wherein said one of said responding staff members is selected based on a respective sales closing performance of each of said responding staff members.

46. The method according to claim 28, wherein said one of said responding staff members is selected based on a respective skill level of each of said responding staff members.

47. The method according to claim 28, wherein the selected one of said responding staff members is the one of the responding staff members determined to be best qualified to handle the information inquiry based on certain predetermined selection logic.

48. The method according to claim 27, wherein direct communication comprises a direct electronic communication between the selected one of said responding staff members and said customer.

49. The method according to claim 27, wherein said call center is a collocated call center having geographically collocated staff members.

50. The method according to claim 27, wherein said call center is a non-collocated call center having geographically dispersed staff members.

51. The method according to claim 27, wherein said call center is hybrid of a collocated call center having certain geographically collocated staff members and a non-collocated call center having geographically dispersed staff members.

52. The method according to claim 10, wherein a transcript of said online chat is provided by said call center to the selected one of said responding staff members prior to the initiation of or during the course of said direct communication.

53. The method according to claim 33, further comprising receiving a transcript of said online chat from said call center prior to the initiation of or during the course of said direct communication.
